(19) United States
(12) Patent Application Publication
(10) Pub. No.: US 2015/0157012 A1
(43) Pub. Date: Jun. 11, 2015

(54) Highly Concentrated Aqueous Formulation Comprising an Anionic Pesticide and a Base

(71) Applicant: BASF SE, Ludwigshafen (DE)

(72) Inventors: Gerhard Schnabel, Elsenfeld (DE); Joanna Mecfel-Marczewski, Limburgerhof (DE); Marc Nolte, Mannheim (DE); Christain Spangler, Offstein (DE)

(21) Appl. No.: 14/412,054

(22) PCT Filed: Jul. 2, 2013
(86) PCT No.: PCT/EP2013/063941

§ 371 Date: Dec. 30, 2014

Related U.S. Application Data
(60) Provisional application No. 61/667,451, filed on Jul. 3, 2012.

(30) Foreign Application Priority Data
Jul. 3, 2012 (EP) 12174776.0

(51) Int. Cl. A01N 25/04; A01N 25/30; A01N 25/24; A01N 37/40

(52) U.S. Cl. CPC A01N 25/04; A01N 37/40; A01N 25/30; A01N 25/24

(57) ABSTRACT

The present invention relates to an aqueous composition comprising at least 200 g/l of an anionic pesticide and at least 50 g/l of an inorganic base. It further relates to a method for preparing the composition comprising the step of contacting the anionic pesticide and the inorganic base; a method of combating harmful insects and/or phytopathogenic fungi, which comprises contacting plants, seed, soil or habitat of plants in or on which the harmful insects and/or phytopathogenic fungi are growing or may grow, plants, seed or soil to be protected from attack or infestation by said harmful insects and/or phytopathogenic fungi with an effective amount of the composition; and to a method of controlling undesired vegetation, which comprises allowing a herbicidal effective amount of the composition to act on plants, their habitat or on seed of said plants.

The present invention relates to an aqueous composition comprising at least 200 g/l of an anionic pesticide and at least 50 g/l of an inorganic base. It further relates to a method for preparing the composition comprising the step of contacting the anionic pesticide and the inorganic base; a method of combating harmful insects and/or phytopathogenic fungi, which comprises contacting plants, seed, soil or habitat of plants in or on which the harmful insects and/or phytopathogenic fungi are growing or may grow, plants, seed or soil to be protected from attack or infestation by said harmful insects and/or phytopathogenic fungi with an effective amount of the composition; and to a method of controlling undesired vegetation, which comprises allowing a herbicidal effective amount of the composition to act on plants, their habitat or on seed of said plants. The present invention comprises combinations of preferred features with other preferred features.

Agrochemical formulations in form of aqueous composition are welcome by many framers due to their easy of handling, low odor of organic solvents and environmental friendly water as solvent. High concentrations of pesticides are very important to reduce the amount of pesticidal inactive water solvent and thus reducing production and transportation costs. However, while increasing the concentration of pesticide in the composition the addition of further components in the aqueous composition is becoming more difficult due to the limited solubility and high salt concentration. Thus, it is an ongoing object to still identify aqueous composition which have a high concentration of pesticide as well as a high concentration of further components.

The object was solved by an aqueous composition comprising at least 200 g/l of an anionic pesticide and at least 50 g/l of an inorganic base.

The composition is usually present in form of an solution, e.g. at 20° C. Typically, the anionic pesticide and the base are dissolved in the aqueous composition. Preferably, all components of the composition are dissolved in the aqueous solution.

The term “pesticide” within the meaning of the invention states that one or more compounds can be selected from the group consisting of fungicides, insecticides, nematicides, herbicide and/or safener or growth regulator, preferably from the group consisting of fungicides, insecticides or herbicides, most preferably from the group consisting of herbicides. Also mixtures of pesticides of two or more the aforementioned classes can be used. The skilled artisan is familiar with such pesticides, which can be, for example, found in the Pesticide Manual, 15th Ed. (2009), The British Crop Protection Council, London.

The anionic pesticide may be present in form of a salt in the composition. The term “salt” refers to chemical compounds, which comprise an anion and a cation. The ratio of anions to cations usually depends on the electric charge of the ions. Typically, salts dissociate when dissolved in water in anions and cations.

Suitable cations are any agrochemically acceptable cations, have no adverse effect on the pesticidal action of the anionic pesticide. Preferred cations are the ions of the alkali metals, preferably sodium and potassium, of the alkaline earth metals, preferably calcium, magnesium and barium, of the transition metals, preferably manganese, copper, zinc and iron, and also the ammonium ion which, if desired, may carry one to four C₁-C₄-alkyl substituents and/or one phenyl or benzyl substituent, preferably diisopropylammonium, tetramethylammonium, tetrabutylammonium, trimethylbenzylammonium, furthermore phosphonium ions, sulfonium ions, preferably tri(C₁-C₄-alkyl)sulfonium, and sulfoxonium ions, preferably tri(C₁-C₄-alkyl)sulfoxonium. Also suitable as cations are the polyamines of the formula (A1) as defined below.

The term “anionic pesticide” refers to a pesticide, which is present as an anion. Preferably, anionic pesticides relate to pesticides comprising a protonizable hydrogen. More preferably, anionic pesticides relate to pesticides comprising a carboxylic, thiocarbonic, sulfonic, sulfinic, thiosulfonic or phosphorous acid group, especially a carboxylic acid group. The aforementioned groups may be partly present in neutral form including the protonizable hydrogen.

Usually, anions such as anionic pesticides comprise at least one anionic group. Preferably, the anionic pesticide comprises one or two anionic groups. In particular the anionic pesticide comprises exactly one anionic group. An example of an anionic group is a carboxylate group (—C(O)O⁻). The aforementioned anionic groups may be partly present in neutral form including the protonizable hydrogen. For example, the carboxylate group may be present partly in neutral form of carboxylic acid (—C(O)OH). This is preferably the case in aqueous compositions, in which an equilibrium of carboxylate and carboxylic acid may be present.

Suitable anionic pesticides are given in the following. In case the names refer to a neutral form or a salt of the anionic pesticide, the anionic form of the anionic pesticides are meant. For example, the anionic form of dicamba may be represented by the following formula:

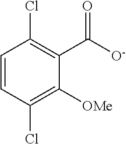 [SMILES: COc1c(Cl)ccc(Cl)c1C(=O)[O-]]

Suitable anionic pesticides are herbicides, which comprise a carboxylic, thiocarbonic, sulfonic, sulfinic, thiosulfonic or phosphorous acid group, especially a carboxylic acid group. Examples are aromatic acid herbicides, phenoxycarboxylic acid herbicides or organophosphorus herbicides comprising a carboxylic acid group.

Suitable aromatic acid herbicides are benzoic acid herbicides, such as diflufenzopyr, naptalam, chloramben, dicamba, 2,3,6-trichlorobenzoic acid (2,3,6-TBA), tricamba; pyrimidinyloxybenzoic acid herbicides, such as bispyribac, pyriminobac; pyrimidinylthiobenzoic acid herbicides, such as pyrithiobac; phthalic acid herbicides, such as chlorthal; picolinic acid herbicides, such as aminopyralid, clopyralid, picloram; quinolinecarboxylic acid herbicides, such as quinclorac, quinmerac; or other aromatic acid herbicides, such as aminocyclopyrachlor. Preferred are benzoic acid herbicides, especially dicamba.

Suitable phenoxycarboxylic acid herbicides are phenoxyacetic herbicides, such as 4-chlorophenoxyacetic acid (4-CPA), (2,4-dichlorophenoxy)acetic acid (2,4-D), (3,4-dichlorophenoxy)acetic acid (3,4-DA), MCPA (4-(4-chloro-o-tolyloxy)butyric acid), MCPA-thioethyl, (2,4,5-trichlorophenoxy)acetic acid (2,4,5-T); phenoxybutyric herbicides, such as 4-CPB, 4-(2,4-dichlorophenoxy)butyric acid (2,4-DB), 4-(3,4-dichlorophenoxy)butyric acid (3,4-DB), 4-(4-chloro-o-tolyloxy)butyric acid (MCPB), 4-(2,4,5-trichlorophenoxy)butyric acid (2,4,5-TB); phenoxypropionic herbicides, such as cloprop, 2-(4-chlorophenoxy)propanoic acid (4-CPP), dichlorprop, dichlorprop-P, 4-(3,4-dichlorophenoxy)butyric acid (3,4-DP), fenoprop, mecoprop, mecoprop-P; aryloxyphenoxypropionic herbicides, such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, trifop. Preferred are phenoxyacetic herbicides, especially MCPA.

Suitable organophosphorus herbicides comprising a carboxylic acid group are bialafos, glufosinate, glufosinate-P, glyphosate. Preferred is glyphosate.

Suitable other herbicides comprising a carboxylic acid are pyridine herbicides comprising a carboxylic acid, such as fluroxypyr, triclopyr; triazolopyrimidine herbicides comprising a carboxylic acid, such as cloransulam; pyrimidinylsulfonylurea herbicides comprising a carboxylic acid, such as bensulfuron, chlorimuron, foramsulfuron, halosulfuron, mesosulfuron, primisulfuron, sulfometuron; imidazolinone herbicides, such as imazamethabenz, imazamethabenz, imazamox, imazapic, imazapyr, imazaquin and imazethapyr; triazolinone herbicides such as flucarbazone, propoxycarbazone and thiencarbazone; aromatic herbicides such as acifluorfen, bifenox, carfentrazone, flufenpyr, flumiclorac, fluoroglycofen, fluthiacet, lactofen, pyraflufen. Further on, chlorflurenol, dalapon, endothal, flamprop, flamprop-M, flupropanate, flurenol, oleic acid, pelargonic acid, TCA may be mentioned as other herbicides comprising a carboxylic acid.

Suitable anionic pesticides are fungicides, which comprise a carboxylic, thiocarbonic, sulfonic, sulfinic, thiosulfonic or phosphorous acid group, espcecially a carboxylic acid group. Examples are polyoxin fungicides, such as polyoxorim.

Suitable anionic pesticides are insecticides, which comprise a carboxylic, thiocarbonic, sulfonic, sulfinic, thiosulfonic or phosphorous acid group, espcecially a carboxylic acid group. Examples are thuringiensin.

Suitable anionic pesticides are plant growth regulator, which comprise a carboxylic, thiocarbonic, sulfonic, sulfinic, thiosulfonic or phosphorous acid group, especially a carboxylic acid group. Examples are 1-naphthylacetic acid, (2-naphthyloxy)acetic acid, indol-3-ylacetic acid, 4-indol-3-ylbutyric acid, glyphosine, jasmonic acid, 2,3,5-triiodobenzoic acid, prohexadione, trinexapac, preferably prohexadione and trinexapac.

Preferred anionic pesticides are anionic herbicides, more preferably dicamba, glyphosate, 2,4-D, aminopyralid, aminocyclopyrachlor and MCPA. Especially preferred are dicamba and glyphosate. In another preferred embodiment, dicamba is preferred. In another preferred embodiment, 2,4-D is preferred. In another preferred embodiment, glyphosate is preferred. In another preferred embodiment, MCPA is preferred.

Various dicamba salts may be used, such as dicamba sodium, dicamba dimethylamine, dicamba diglyclolamine. Dicamba is available in the commercial products like BANVELO+2,4-D, BANVEL HERBICIDE®, BANVEL-K+ATRAZINE®, BRUSHMASTERO, CELEBRITY PLUS®, CIMARRON MAX®, CLARITY HERBICIDE®, COOL POWER®, DIABLO HERBICIDE®, DICAMBA DMA SALT, DISTINCT HERBICIDE®, ENDRUNO, HORSEPOWER*®, LATIGOO, MARKSMAN HERBICIDE®, MACAMINE-D®, NORTHSTAR HERBICIDE®, OUTLAW HERBICIDE®, POWER ZONE®, PROKOZ VESSEL®, PULSAR®, Q4 TURF HERBICIDE®, RANGESTARO, REQUIRE Q®, RIFLE®, RIFLE PLUS®, RIFLE-D®, SPEED ZONE®, STATUS HERBICIDE®, STER-LING BLUE®, STRUT®, SUPER TRIMEC*®, SURGE*®, TRIMEC BENTGRASS*®, TRIMEC CLASSIC*®, TRIMEC PLUS*®, TRIPLET SF®, TROOPER EXTRA®, VANQUISH®, VETERAN 720®, VISION HERBICIDE®, WEEDMASTERO, YUKON HERBICIDE®.

Preferably, the anionic pesticide (e.g. dicamba) is present in form of a polyamine salt and the polyamine has the formula (A1)

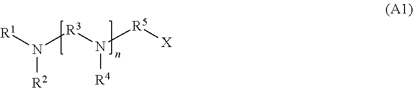

wherein
R¹, R², R⁴, R⁶, and R⁷ are independently H or C₁-C₆-alkyl, which is optionally substituted with OH,
R³ and R⁵ are independently C₂-C₁₀-alkylene,
X is OH or NR⁶R⁷, and
n is from 1 to 20;
or the formula (A2)

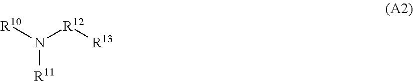

wherein
R¹⁰ and R¹¹ are independently H or C₁-C₆-alkyl,
R¹² is C₁-C₁₂-alkylene, and
R¹³ is an aliphatic C₅-C₈ ring system, which comprises either nitrogen in the ring or which is substituted with at least one unit NR¹⁰R¹¹.

The term “polyamine” within the meaning of the invention relates to an organic compound comprising at least two amino groups, such as an primary, secondary or tertiary amino group.

The polyamine salt usually comprises an anionic pesticides (e.g. dicamba) and a cationic polyamine. The term “cationic polyamine” refers to a polyamine, which is present as cation. Preferably, in a cationic polyamine at least one amino group is present in the cationic form of an ammonium, such as R—N⁺H₃, R₂—N⁺H₂, or R₃—N⁺H. An expert is aware which of the amine groups in the cationic polyamine is preferably protonated, because this depends for example on the pH or the physical form. In aqueous solutions the alkalinity of the amino groups of the cationic polyamine increases usually from tertiary amine to primary amine to secondary amine.

In an embodiment the cationic polyamine has the formula

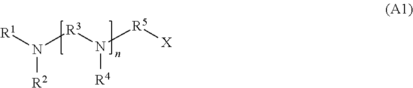

wherein R¹, R², R⁴, R⁶, R⁷ are independently H or C₁-C₆-alkyl, which is optionally substituted with OH, R³ and R⁵ are independently C₂-C₁₀-alkylene, X is OH or NR⁶R⁷, and n is from 1 to 20. R¹, R², R⁴, R⁶ and R⁷ are preferably independently H or methyl. Preferably, R¹, R², R⁶ and R⁷ are H. R⁶ and R⁷ are preferably identical to R¹ and R², respectively. R³ and R⁵ are preferably independently C₂-C₃-alkylene, such as ethylene (—CH₂CH₂—), or n-propylene (—CH₂CH₂CH₂—). Typically, R³ and R⁵ are identical. R³ and R⁵ may be linear or branched, unsubstituted or subsitituted with halogen. Preferably, R³ and R⁵ are linear. Preferably, R³ and R⁵ are unsubstituted. X is preferably NR⁶R⁷. Preferably, n is from 1 to 10, more preferably from 1 to 6, especially from 1 to 4. In another preferred embodiment, n is from 2 to 10. Preferably, R¹, R², and R⁴ are independently H or methyl, R³ and R⁵ are independently C₂-C₃-alkylene, X is OH or NR⁶R⁷, and n is from 1 to 10.

The group X is bound to R⁵, which is a C₂-C₁₀-alkylene group. This means that X may be bound to any carbon atom of the C₂-C₁₀-alkylene group. Examples of a unit —R⁵—X are —CH₂—CH₂—CH₂—OH or —CH₂—CH(OH)—CH₃.

R¹, R², R⁴, R⁶, R⁷ are independently H or C₁-C₆-alkyl, which is optionally substituted with OH. An example such a substitution is formula (B1.9), in which R⁴ is H or C₁-C₆-alkyl substituted with OH (more specifically, R⁴ is C₃-alkyl substituted with OH. Preferably, R¹, R², R⁴, R⁶, R⁷ are independently H or C₁-C₆-alkyl.

In another preferred embodiment the cationic polymer of the formula (A1) is free of ether groups (—O—). Ether groups are known to enhance photochemical degradation resulting in explosive radicals or peroxy groups.

Examples for cationic polyamines of the formula (A1) wherein X is NR⁶R⁷ are diethylenetriamine (DETA, (A4) with k=1, corresponding to (A1.1)), triethylenetetraamine (TETA, (A4) with k=2), tetraethylenepentaamine (TEPA, (A4) with k=3). Technical qualities of TETA are often mixtures comprising in addition to linear TETA as main component also tris-aminoethylamine TAEA, Piperazinoethylethylenediamine PEEDA and Diaminoethylpiperazine DAEP. Technical qualities of TEPA a are often mixtures comprising in addition to linear TEPA as main component also aminoethyltris-aminoethylamine AE-TAEA, aminoethyldiaminoethylpiperazine AE-DAEP and aminoethylpiperazinoethylethylenediamine AE-PEEDA. Such ethyleneamines are commercially available from Dow Chemical Company. Further examples are Pentamethyldiethylenetriamine PMDETA (B1.3), N,N,N′,N″,N″-pentamethyl-dipropylenetriamine (B1.4) (commercially available as Jeffcat® ZR-40), N,N-bis(3-dimethylaminopropyl)-N-isopropanolamine (commercially available as Jeffcat® ZR-50), N′-(3-(dimethylamino)propyl)-N,N-dimethyl-1,3-propanediamine (A1.5) (commercially available as Jeffcat® Z-130), and N,N-Bis(3-aminopropyl)methylamine BAPMA (A1.2). Especially preferred are (A4), wherein k is from 1 to 10, (A1.2), (A1.4) and (A1.5). Most preferred are (A4), wherein k is 1, 2, 3, or 4 and (A1.2). In particular preferred are (A1.1) and (A1.2), wherein the latter is most preferred.

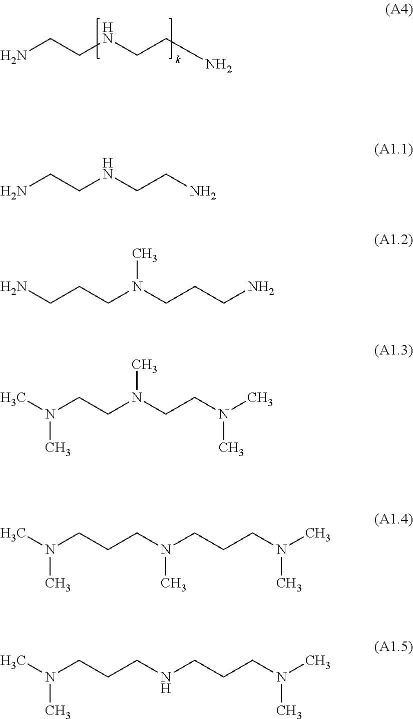

Examples for polyamines of the formula (A1) wherein X is OH are N-(3-dimethylaminopropyl)-N,N-diisopropanolamine DPA (A1.9), N,N,N′-trimethylaminoethyl-ethanolamine (A1.7) (commercially available as Jeffcat® Z-110), aminopropylmonomethylethanolamine APMMEA (A1.8), and aminoethylethanolamine AEEA (A1.6). Especially preferred is (A1.6).

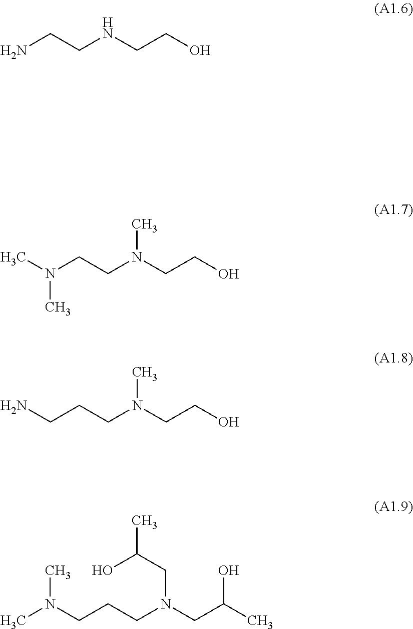

In another embodiment the cationic polyamine has the formula

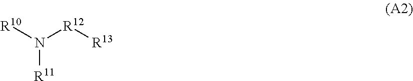

wherein R¹⁰ and R¹¹ are independently H or C₁-C₆-alkyl, R¹² is C₂-C₁₂-alkylene, and R¹³ is an aliphatic C₅-C₈ ring system, which comprises either nitrogen in the ring or which is substituted with at least one unit NR₁₀R₁₁.

R¹⁰ and R¹¹ are preferably independently H or methyl, more preferably H. Typically R¹⁰ and R¹¹ are linear or branched, unsubstituted or substituted with halogen. Preferably, R¹⁰ and R¹¹ are unsubstituted and linear. More preferably, R¹⁰ and R¹¹ are identical.

R¹² is preferably C₂-C₄-alkylene, such as ethylene (—CH₂CH₂—), or n-propylene (—CH₂CH₂CH₂—). R¹² may be linear or branched, preferably it is linear. R¹² may be unsubstituted or substituted with halogen, preferably it is unsubstituted.

R¹³ is an aliphatic C₅-C₈ ring system, which comprises either nitrogen in the ring or which is substituted with at least one unit NR¹⁰R¹¹. Preferably, R¹³ is an aliphatic C₅-C₈ ring system, which comprises nitrogen in the ring. The C₅-C₈ ring system may be unsubstituted or substituted with at least one C₁-C₆ alkyl group or at least one halogen. Preferably, the C₅-C₈ ring system is unsubstituted or substituted with at least one C₁-C₄ alkyl group. Examples for an aliphatic C₅-C₈ ring system, which comprises nitrogen in the ring, are piperazyl groups. Examples for R¹³ being an aliphatic C₅-C₈ ring system, which comprises nitrogen in the ring, are the compounds of the formulat (A2.11) and (A2.12) below. Examples for R¹³ being an aliphatic C₅-C₈ ring system, which is substituted with at least one unit NR¹⁰R¹¹ is the compound of the formula (A2.10) below.

More preferably, R¹⁰ and R¹¹ are independently H or methyl, R¹² is C₂-C₃-alkylene, and R¹³ is an aliphatic C₅-C₈ ring system, which comprises oxygen or nitrogen in the ring. In another preferred embodiment the cationic polymer of the formula (A2) is free of ether groups (—O—).

Especially preferred cationic polyamines of formula (A2) are isophorone diamine ISPA (A2.10), aminoethylpiperazine AEP (A2.11), and 1-methyl-4-(2-dimethylaminoethyl)piperazine TAP (A2.12). These compounds are commercially available from Huntsman or Dow, USA. Preferred are (A2.10) and (A2.11), more preferably (A2.11). In another embodiment (A2.11) and (A2.12) are preferred.

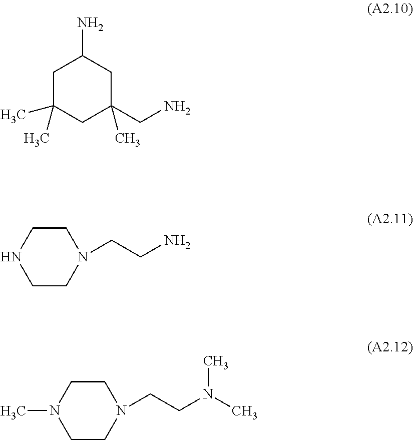

Dicamba is most preferred present in form of a N,N-bis(3-aminopropyl)methylamine (so called “BAPMA”) salt.

The aqeuous composition may comprise additional pesticides in addition to dicamba. Suitable additional pesticides are pesticides as defined below. Preferred additional pesticides are herbicides, such as
amino acid derivatives: bilanafos, glyphosate (e.g. glyphosate free acid, glyphosate ammonium salt, glyphosate isopropylammonium salt, glyphosate trimethylsulfonium salt, glyphosate potassium salt, glyphosate dimethylamine salt), glufosinate, sulfosate;
imidazolinones: imazamethabenz, imazamox, imazapic, imazapyr, imazaquin, imazethapyr;
phenoxy acetic acids: clomeprop, 2,4-dichlorophenoxyacetic acid (2,4-D), 2,4-DB, dichlorprop, MCPA, MCPA-thioethyl, MCPB, Mecoprop.

More preferred additional pesticides are glyphosate and 2,4-D. Most preferred additional pesticide is glyphosate.

The anionic pesticide may be water-soluble. The anionic pesticide may have a solubility in water of at least 10 g/l, preferably at least 50 g/l, and in particular at least 100 g/l at 20° C.

The composition contains usually at least 250 g/l, preferably at least 300 g/l, more preferably at least 350 g/l, and in particular at least 370 g/l of the anionic pesticide (e.g. acid equivalents (AE) of dicamba). The composition contains usually up to 800 g/l, preferably up to 700 g/l, more preferably up to 650 g/l, and in particular up to 600 g/l anionic pesticide (e.g. acid equivalents (AE) of dicamba). In case more than one anionic pesticide is present in the composition, the aforementioned amounts refer to the sum of all anionic pesticides.

Typically, the inorganic base contains at least one inorganic base. Examples for inorganic bases are a carbonate, a phosphate, a hydroxide, a silicate, a borate, an oxide, or mixtures thereof. In a preferred form the base comprises a carbonate. In another preferred form the base comprises a phosphate. In another preferred form the base comprises a hydroxide. In another preferred form the base comprises an oxide. In another preferred form the base comprises a borate. In another preferred form the base comprises a silicate.

Suitable carbonates are alkaline or earth alkaline salts of CO3⁻ or of HCO₃⁻ (Hydrogencarbonates). Alkali salts usually refer to salts containing preferably sodium and/or potassium as cations.

Preferred carbonates are sodium carbonate or potassium carbonate, wherein the latter is preferred.

In another preferred form carbonates are alkali salts of CO3²⁻ or of HCO₃⁻. Especially preferred carbonates are selected from sodium carbonate, sodium hydrogencarbonate, potassium carbonate, potassium hydrogencarbonate, and mixtures thereof.

Mixtures of carbonates are also possible. Preferred mixtures of carbonates comprise alkali salts of CO₃²⁻ and alkali salts of HCO₃⁻. Especially preferred mixtures of carbonates comprise potassium carbonate and potassium hydrogencarbonate; or sodium carbonate and sodium hydrogencarbonate. The weight ratio of alkali salts of CO₃²⁻ (e.g. K₂CO₃) to alkali salts of HCO₃⁻ (e.g. KHCO₃) may be in the range of 1:20 to 20:1, preferably 1:10 to 10:1. In another form, the weight ratio of alkali salts of CO₃²⁻ (e.g. K₂CO₃) to alkali salts of HCO₃ (e.g. KHCO₃) may be in the range of 1:1 to 1:25, preferably of 1:2 to 1:18, and in particular of 1:4 to 1:14.

Suitable phosphates are alkaline or earth alkaline salts of secondary or tertiary phosphates, pyrrophosphates, and oligophosphates. Potassium salts of phosphates are preferred, such as Na₃PO₄, Na₂HPO₄, and NaH₂PO₄, and mixtures thereof.

Suitable hydroxides are alkaline, earth alkaline, or organic salts of hydroxides. Preferred hydroxides are NaOH, KOH and choline hydroxide, wherein KOH and choline hydroxide are preferred.

Suitable silicates are alkaline or earth alkaline silicates, such as potassium silicates.

Suitable borates are alkaline or earth alkaline borates, such as potassium, sodium or calcium borates. Fertilizers containing borates are also suitable.

Suitable oxides are alkaline or earth alkaline oxides, such as calcium oxide or magnesium oxide. In a preferred form oxides are used together with chelating bases.

In a more preferred form the base is selected from a carbonate, a phosphate, or a mixture thereof. Preferably, the base is selected from an alkali salt of a carbonate, an alkali salt of hydrogencarbonate, or mixtures thereof. The carbonate and the phosphate may be present in any crystal! modification, in pure form, as technical quality, or as hydrates (e.g. K2CO3×1.5 H₂O).

The base may be present in dispersed or dissolved form, wherein the dissolved form is preferred.

The base has preferably has a solubility in water of at least 1 g/l at 20° C., more preferably of at least 10 g/l, and in particular at least 100 g/l.

The composition contains usually at least 50 g/l, preferably at least 100 g/l, more preferably at least 130 g/l, and in particular at least 180 g/l of the base (e.g. carbonate). The composition contains usually up to 400 g/l, preferably up to 350 g/l, more preferably up to 300 g/l, and in particular up to 250 g/l base (e.g. carbonate). In case more than one base is present in the composition, the aforementioned amounts refer to the sum of all bases. The concentration given in WI units is based on the molar weight of all ions of which the base might be formed (e.g. potassium and carbonate), but not only on the alkaline ion. If the base is present as hydrate (e.g. potassium carbonate hydrate), the hydrate is not included for calculation of the concentration.

The composition contains usually a total of at least 400 g/l, preferably at least 500 g/l, and in particular at least 520 g/l of the sum of the anionic pesticide (e.g. acid equivalents of dicamba) and the base (e.g. carbonate). The composition contains usually a total of up to 800 g/l, preferably at least 700 g/l, and in particular at least 650 g/l of the sum of the anionic pesticide (e.g. acid equivalents of dicamba) and the base (e.g. carbonate).

The molar ratio of the anionic pesticide to the base may be from 30:1 to 1:10, preferably from 10:1 to 1:5, and in particular from 3:1 to 1:1.5. For calculation of the molar ratio, the sum of all bases (e.g. CO3²⁻ and HCO3⁻) except the further base may be applied. For calculation of the molar ratio, the sum of all anionic pesticides may be applied. For calculation of the molar ratio, the only the alkaline ions of the bases are considered, but not the respective counterions (e.g. the alkaline ion CO₃²⁻, but not the two potassium counterions).

The composition may additionally comprise a drift control agent of the formula (I)

R^{a}—O—(CₘH₂ₘ—O)ₙ—H (I)

wherein R^{a} is C₈-C₂₂-alkyl and/or -alkenyl, m is 2, 3, 4 or a mixture thereof, and n is from 1 to 15. The drift control agents of the formula (I) are alkoxylates, which are obtainable by common alkoxylation of alcohols R^{a}—OH, e.g. with ethylene oxide (resulting in m=2), propylene oxide, or butylene oxide.

R^{a} may be an alkyl, alkenyl or a mixture thereof. Preferably R^{a} is an alkenyl or a mixture of an alkenyl with an alkyl. In case Rₐ contains an alkenyl said alkenyl may comprise at least one double bond. R^{a} is preferably a C₁₂-C₂₀-alkyl and/or -alkenyl. More preferably R^{a} is G₁₆-G₁₈-alkyl and/or -alkenyl. Especially preferred R^{a} is oleyl and/or cetyl.

Preferably, m is 2, a mixture of 2 and 3, or a mixture of 2 and 4. In particular, m is 2.

Preferably, n is from 2 to 8. In particular, n is from 2 to 5.

In a very preferred form of the drift control of the formula (I), R^{a} is C₁₂-C₂₀-alkyl and/or -alkenyl, m is 2, a mixture of 2 and 3, or a mixture of 2 and 4, and n is from 2 to 8. In an even more preferred form of the drift control agent R^{a} is C₁₆-C₁₈-alkyl and/or -alkenyl, m is 2, and n is from 2 to 5.

The composition contains usually at least 5 g/l, preferably at least 20 g/l, and in particular at least 30 g/l of the drift control agent of the formula (I). The composition contains usually up 300 g/l, preferably up to 200 g/l, and in particular up to 150 g/l of the drift control agent of the formula

The composition may additionally comprise a sugar-based surfactant. Suitable sugar-based surfactants may contain a sugar, such as a mono-, di-, oligo-, and/or polysaccharide. Mixtures of different sugar-based surfactants are possible. Examples of sugar-based surfactants are sorbitans, ethoxylated sorbitans, sucrose esters and glucose esters or alkyl polyglucosides. Preferred sugar-based surfactants are alkyl polyglycosides.

The alkyl polyglucosides are usually mixtures of alkyl monoglucosid (e.g. alkyl-α-D- and -β-D-glucopyranoside, optionally containing smaller amounts of -glucofuranoside), alkyl diglucosides (e.g. -isomaltosides, -maltosides) and alkyl oligoglucosides (e.g. -maltotriosides, -tetraosides). Preferred alkyl polyglucosides are C₄-C₁₈-alkyl polyglucosides, more preferably C₆₋₁₄-alkyl polyglucosides, and in particular C₆₋₁₂-alkyl polyglucosides. The alkyl polyglucosides may have a D.P. (degree of polymerization) of from 1.2 to 1.9. More preferred are C₆₋₁₀-alkylpolyglycosides with a D.P. of from 1.4 to 1.9. The alkyl polyglycosides usually have a HLB value of 11.0 to 15.0, preferably of 12.0 to 14.0, and in particular from 13.0 to 14.0.

In another preferred form alkyl polyglucosides are C₆₋₈-alkyl polyglucosides. In another form, the alkyl polyglycosides (e.g. C₆₋₈-alkyl polyglucosides) have a HLB value according to Davies of at least 15, preferably at least 20.

The surface tension of the alkyl polyglucosides is usually 28 to 37 mN/m, preferably 30 to 35 mN/m, and in particular 32 to 35 mN/m and may be determined according to DIN53914 (25° C., 0.1%).

The composition contains usually at least 10 g/l, preferably at least 40 g/l, and in particular at least 60 g/l of the sugar-based surfactant (e.g. alkyl polyglucoside). The composition contains usually up 300 g/l, preferably up to 230 g/l, and in particular up to 170 g/l the sugar-based surfactant (e.g. alkyl polyglucoside).

In a preferred form the composition comprises at least 350 g/l of the anionic pesticide (e.g. acid equivalents of dicamba), at least 100 g/l of the base (e.g. carbonate), and at least 30 g/l of the drift control agent (e.g. wherein R^{a} is C₁₂-C₂₀-alkyl and/or -alkenyl, m is 2, a mixture of 2 and 3, or a mixture of 2 and 4, and n is from 2 to 8).

In a more preferred form the composition comprises at least 350 g/l of the anionic pesticide which contains dicamba, at least 100 g/l of the base which contains sodium carbonate, sodium hydrogencarbonate, potassium carbonate, potassium hydrogencarbonate, or mixtures thereof, and at least 30 g/l of the drift control agent, in which R^{a} is C₁₆-C₁₈-alkyl and/or -alkenyl, m is 2, and n is from 2 to 5.

The composition may comprise auxiliaries. Examples for suitable auxiliaries are solvents, liquid carriers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders. Usually, the composition contains up to 10 wt %, preferably up to 5 wt %, and in particular up to 2 wt % of auxiliaries.

Suitable solvents and liquid carriers are organic solvents, such as mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof. Preferably, the compositon contains up to 10 wt %, more preferably up to 3 wt %, and in particular substantially no solvents.

Suitable surfactants are surface-active compounds, such as anionic, cationic, nonionic and amphoteric surfactants, block polymers, polyelectrolytes, and mixtures thereof. Such surfactants can be used as emusifier, dispersant, solubilizer, wetter, penetration enhancer, protective colloid, or adjuvant. Examples of surfactants are listed in McCutcheon's, Vol. 1: Emulsifiers & Detergents, McCutcheon's Directories, Glen Rock, USA, 2008 (International Ed. or North American Ed.). The drift control agent of the formula (I) and the sugar-based surfactants are not considered by the term “surfactant” within the meaning of this invention.

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, lignine sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates.

Suitable nonionic surfactants are alkoxylates, N-subsituted fatty acid amides, amine oxides, esters, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-subsititued fatty acid amides are fatty acid glucamides or fatty acid alkanolamides. Examples of esters are fatty acid esters, glycerol esters or monoglycerides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide. Suitable polyelectrolytes are polyacids or polybases. Examples of polyacids are alkali salts of polyacrylic acid or polyacid comb polymers. Examples of polybases are polyvinylamines or polyethyleneamines.

Suitable adjuvants are compounds, which have a negligible or even no pesticidal activity themselves, and which improve the biological performance of the anionic pesticide on the target. Examples are surfactants, mineral or vegetable oils, and other auxilaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), anorganic clays (organically modified or unmodified), polycarboxylates, and silicates. Suitable bactericides are bronopol and isothiazolinone derivatives such as alkylisothiazolinones and benzisothiazolinones. Suitable anti-freezing agents are ethylene glycol, propylene glycol, urea and glycerin. Suitable anti-foaming agents are silicones, long chain alcohols, and salts of fatty acids. Suitable colorants (e.g. in red, blue, or green) are pigments of low water solubility and water-soluble dyes. Examples are inorganic colorants (e.g. iron oxide, titan oxide, iron hexacyanoferrate) and organic colorants (e.g. alizarin-, azo- and phthalocyanine colorants).

The present invention also relates to a method for preparing the composition comprising the step of contacting the anionic pesticide and the base. The contacting may be done by mixing at ambient temperatures.

The present invention also relates to a method of combating harmful insects and/or phytopathogenic fungi, which comprises contacting plants, seed, soil or habitat of plants in or on which the harmful insects and/or phytopathogenic fungi are growing or may grow, plants, seed or soil to be protected from attack or infestation by said harmful insects and/or phytopathogenic fungi with an effective amount of the composition.

The present invention also relates to a method of controlling undesired vegetation, which comprises allowing a herbicidal effective amount of the composition to act on plants, their habitat or on seed of said plants. In a preferred embodiment, the method may also include plants that have been rendered tolerant to the application of the agrochemical formulation wherein the anionic pesticide is a herbicide. The methods generally involve applying an effective amount of the agrochemical formulation of the invention comprising a selected herbicide to a cultivated area or crop field containing one or more crop plants which are tolerant to the herbicide. Although any undesired vegetation may be controlled by such methods, in some embodiments, the methods may involve first identifying undesired vegetation in an area or field as susceptible to the selected herbicide. Methods are provided for controlling the undesired vegetation in an area of cultivation, preventing the development or the appearance of undesired vegetation in an area of cultivation, producing a crop, and increasing crop safety. Undesired vegetation, in the broadest sense, is understood as meaning all those plants which grow in locations where they are undesired, which include but is not limited to plant species generally regarded as weeds.

In addition, undesired vegetation can also include undesired crop plants that are growing in an identified location. For example, a volunteer maize plant that is in a field that predominantly comprises soybean plants can be considered undesirable. Undesired plants that can be controlled by the methods of the present invention include those plants that were previously planted in a particular field in a previous season, or have been planted in an adjacent area, and include crop plants including soybean, corn, canola, cotton, sunflowers, and the like. In some aspects, the crop plants can be tolerant of herbicides, such as glyphosate, ALS-inhibitors, or glufosinate herbicides. The methods comprise planting the area of cultivation with crop plants which are tolerant to the herbicide, and in some embodiments, applying to the crop, seed, weed, undesired plant, soil, or area of cultivation thereof an effective amount of an herbicide of interest. The herbicide can be applied at any time during the cultivation of the tolerant plants. The herbicide can be applied before or after the crop is planted in the area of cultivation. Also provided are methods of controlling glyphosate tolerant weeds or crop plants in a cultivated area comprising applying an effective amount of herbicide other than glyphosate to a cultivated area having one or more plants that are tolerant to the other herbicide.

The term “herbicidal effective amount” denotes an amount of pesticidal active component, such as the salts or the further pesticide, which is sufficient for controlling undesired vegetation and which does not result in a substantial damage to the treated plants. Such an amount can vary in a broad range and is dependent on various factors, such as the species to be controlled, the treated cultivated plant or material, the climatic conditions and the specific pesticidal active component used.

The term “controlling weeds” refers to one or more of inhibiting the growth, germination, reproduction, and/or proliferation of; and/or killing, removing, destroying, or otherwise diminishing the occurrence and/or activity of a weed and/or undesired plant.

The composition according to the invention has excellent herbicidal activity against a broad spectrum of economically important monocotyledonous and dicotyledonous harmful plants, such as broad-leaved weeds, weed grasses or Cyperaceae. The active compounds also act efficiently on perennial weeds which produce shoots from rhizomes, root stocks and other perennial organs and which are difficult to control. Specific examples may be mentioned of some representatives of the monocotyledonous and dicotyledonous weed flora which can be controlled by the composition according to the invention, without the enumeration being restricted to certain species. Examples of weed species on which the herbicidal compositions act efficiently are, from amongst the monocotyledonous weed species, Avena spp., Alopecurus spp., Apera spp., Brachiaria spp., Bromus spp., Digitaria spp., Lolium spp., Echinochloa spp., Leptochloa spp., Fimbristylis spp., Panicum spp., Phalaris spp., Poa spp., Setaria spp. and also Cyperus species from the annual group, and, among the perennial species, Agropyron, Cynodon, Imperata and Sorghum and also perennial Cyperus species. In the case of the dicotyledonous weed species, the spectrum of action extends to genera such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. Eclipta spp., Sesbania spp., Aeschynomene spp. and Viola spp., Xanthium spp. among the annuals, and Convolvulus, Cirsium, Rumex and Artemisia in the case of the perennial weeds.

Depending on the application method in question, the compositions according to the invention can additionally be employed in a further number of crop plants for eliminating undesirable plants. Examples of suitable crops are the following:

Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Brassica juncea, Brassica campestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N.rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

Preferred crops are: Arachis hypogaea, Beta vulgaris spec. altissima, Brassica napus var. napus, Brassica oleracea, Brassica juncea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays

The compositions according to the invention can also be used in genetically modified plants. The term “genetically modified plants” is to be understood as plants, which genetic material has been modified by the use of recombinant DNA techniques in a way that under natural circumstances it cannot readily be obtained by cross breeding, mutations, natural recombination, breeding, mutagenesis, or genetic engineering. Typically, one or more genes have been integrated into the genetic material of a genetically modified plant in order to improve certain properties of the plant. Such genetic modifications also include but are not limited to targeted posttranstional modification of protein(s), oligo- or polypeptides e. g. by glycosylation or polymer additions such as prenylated, acetylated or farnesylated moieties or PEG moieties.

Plants that have been modified by breeding, mutagenesis or genetic engineering, e.g. have been rendered tolerant to applications of specific classes of herbicides, are particularly useful with the compositions according to the invention. Tolerance to classes of herbicides has been developed such as auxin herbicides such as dicamba or 2,4-D; bleacher herbicides such as hydroxyphenylpyruvate dioxygenase (HPPD) inhibitors or phytoene desaturase (PDS) inhibitors; acetolactate synthase (ALS) inhibitors such as sulfonyl ureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase (PPO) inhibitors; lipid biosynthesis inhibitors such as acetyl CoA carboxylase (ACCase) inhibitors; or oxynil (i. e. bromoxynil or ioxynil) herbicides as a result of conventional methods of breeding or genetic engineering. Furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxin herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Examples of these herbicide resistance technologies are also described in US 2008/0028482, US2009/0029891, WO 2007/143690, WO 2010/080829, U.S. Pat. No. 6,307,129, U.S. Pat. No. 7,022,896, US 2008/0015110, U.S. Pat. No. 7,632,985, U.S. Pat. No. 7,105,724, and U.S. Pat. No. 7,381,861, each herein incorporated by reference.

Several cultivated plants have been rendered tolerant to herbicides by conventional methods of breeding (mutagenesis), e. g. Clearfield® summer rape (Canola, BASF SE, Germany) being tolerant to imidazolinones, e. g. imazamox, or ExpressSun® sunflowers (DuPont, USA) being tolerant to sulfonyl ureas, e. g. tribenuron. Genetic engineering methods have been used to render cultivated plants such as soybean, cotton, corn, beets and rape, tolerant to herbicides such as glyphosate, dicamba, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as ä-endotoxins, e. g. CryIA(b), CryIA(c), CryIF, CryIF(a2), CryIIA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, e. g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be under-stood expressly also as pre-toxins, hybrid proteins, truncated or otherwise modified proteins. Hybrid proteins are characterized by a new combination of protein domains, (see, e. g. WO 02/015701). Further examples of such toxins or genetically modified plants capable of synthesizing such toxins are dis-closed, e. g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e. g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e. g., described in the publications mentioned above, and some of which are commercially available such as YieldGard® (corn cultivars producing the CrylAb toxin), YieldGard® Plus (corn cultivars producing CrylAb and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the CrylAc toxin), Bollgard® I (cotton cultivars producing the CrylAc toxin), Bollgard® II (cotton cultivars producing CrylAc and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e. g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP-A 392 225), plant disease resistance genes (e. g. potato culti-vars, which express resistance genes acting against Phytophthora infestans derived from the mexican wild potato Solanum bulbocastanum) or T4-lyso-zym (e.g. potato cultivars capable of synthesizing these proteins with increased resistance against bacteria such as Erwinia amylvora). The methods for producing such genetically modi-fied plants are generally known to the person skilled in the art and are described, e.g. in the publications mentioned above.

Furthermore, plants are also covered that are by the use of recombinant DNA techniques capable to synthesize one or more proteins to increase the productivity (e.g. bio mass production, grain yield, starch content, oil content or protein content), tolerance to drought, salinity or other growth-limiting environ-mental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e. g. oil crops that produce health-promoting long-chain omega-3 fatty acids or unsaturated omega-9 fatty acids (e. g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

Furthermore, it has been found that the compositions according to the invention are also suitable for the defoliation and/or desiccation of plant parts, for which crop plants such as cotton, potato, oilseed rape, sunflower, soybean or field beans, in particular cotton, are suitable. In this regard compositions have been found for the desiccation and/or defoliation of plants, processes for preparing these compositions, and methods for desiccating and/or defoliating plants using the compositions according to the invention.

As desiccants, the compositions according to the invention are suitable in particular for desiccating the above-ground parts of crop plants such as potato, oilseed rape, sunflower and soybean, but also cereals. This makes possible the fully mechanical harvesting of these important crop plants.

Also of economic interest is the facilitation of harvesting, which is made possible by concentrating within a certain period of time the dehiscence, or reduction of adhesion to the tree, in citrus fruit, olives and other species and varieties of pomaceous fruit, stone fruit and nuts. The same mechanism, i.e. the promotion of the development of abscission tissue between fruit part or leaf part and shoot part of the plants is also essential for the controlled defoliation of useful plants, in particular cotton. Moreover, a shortening of the time interval in which the individual cotton plants mature leads to an increased fiber quality after harvesting.

The compositions according to the invention are applied to the plants mainly by spraying the leaves. Here, the application can be carried out using, for example, water as carrier by customary spraying techniques using spray liquor amounts of from about 100 to 1000 l/ha (for example from 300 to 400 l/ha). The herbicidal compositions may also be applied by the low-volume or the ultra-low-volume method, or in the form of microgranules.

The herbicidal compositions according to the present invention can be applied pre- or post-emergence, or together with the seed of a crop plant. It is also possible to apply the compounds and compositions by applying seed, pretreated with a composition of the invention, of a crop plant. If the active compounds A and C and, if appropriate C, are less well tolerated by certain crop plants, application techniques may be used in which the herbicidal compositions are sprayed, with the aid of the spraying equipment, in such a way that as far as possible they do not come into contact with the leaves of the sensitive crop plants, while the active compounds reach the leaves of undesirable plants growing underneath, or the bare soil surface (post-directed, lay-by).

In a further embodiment, the composition according to the invention can be applied by treating seed. The treatment of seed comprises essentially all procedures familiar to the person skilled in the art (seed dressing, seed coating, seed dusting, seed soaking, seed film coating, seed multilayer coating, seed encrusting, seed dripping and seed pelleting) based on the compositions according to the invention. Here, the herbicidal compositions can be applied diluted or undiluted.

The term seed comprises seed of all types, such as, for example, corns, seeds, fruits, tubers, seedlings and similar forms. Here, preferably, the term seed describes corns and seeds.

The seed used can be seed of the useful plants mentioned above, but also the seed of transgenic plants or plants obtained by customary breeding methods.

The rates of application of the active compound are from 0.0001 to 3.0, preferably 0.01 to 1.0 kg/ha of active substance (a.s.), depending on the control target, the season, the target plants and the growth stage. To treat the seed, the pesticides are generally employed in amounts of from 0.001 to 10 kg per 100 kg of seed.

Moreover, it may be advantageous to apply the compositions of the present invention on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.

When employed in plant protection, the amounts of active substances applied are, depending on the kind of effect desired, from 0.001 to 2 kg per ha, preferably from 0.005 to 2 kg per ha, more preferably from 0.05 to 0.9 kg per ha, in particular from 0.1 to 0.75 kg per ha. In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kilogram of plant propagation material (preferably seed) are generally required.

Various types of oils, wetters, adjuvants, fertilizer, or micronutrients, and other pesticides (e.g. herbicides, insecticides, fungicides, growth regulators, safeners) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

The user applies the composition according to the invention usually from a predosage device, a knapsack sprayer, a spray tank, a spray plane, or an irrigation system. Usually, the agrochemical composition is made up with water, buffer, and/or further auxiliaries to the desired application concentration and the ready-to-use spray liquor or the agrochemical composition according to the invention is thus obtained. Usually, 20 to 2000 liters, preferably 50 to 400 liters, of the ready-to-use spray liquor are applied per hectare of agricultural useful area.

The present invention offers various advantages: it reduced spray drift fines and off-target movement of pesticide (e.g. dicamba) applications compared to current available formulations, while maintaining use friendly handling and use characteristics, and without adversely affecting their pesticidal activity. The compositions reduced driftable fines at a lower adjuvant use rate in the spray tank in comparison to commercial standard applied as a tank mix. Further advantages of the invention are good adhesion of the pesticide on the surface of the treated plants, increased permeation of the pesticides into the plant and, as a result, more rapid and enhanced activity. Another advantage is the low harmful effect against crop plants, i.e., low phytotoxic effects. Another advantage is that the volatility of pesticides (e.g. auxin herbicides like dicamba, or 2,4-D) is reduced; or that no additional drift control agent needs to be added to the tank mix, thus allowing an easy and safe preparation of the tank mix. Further on, the high concentration of the pesticide, the base and optionally the drift control agent are very advantageous. The high concentration of the base allows to avoid the addition of a tank mix adjuvant including such a base.

The invention is further illustrated but not limited by the following examples.

### EXAMPLES

Antidrift A: Ethoxylated Cetyl/Oleylalcohol (degree of ethoxylation about 3), HLB about 6,6 according to Griffin.
Surfactant A: Nonionic C8/10 alkylpolyglycosid (about 70 wt % active content and 30 wt % water), viscous liquid, HLB 13-14.
Surfactant B: Nonionic C8 alkylpolyglycosid (about 65 wt % active content and 35 wt % water), viscosity about 260-275 mPas (25° C.).
Surfactant C: Sodium alkyl naphthalene sulfonate, surface tension about 32 mN/m (25° C., 0.1%).

### Example 1

The aqueous solutions A to G were prepared by dissolving the components as indicated in Table 1 in water at room temperature while stirring. Dicamba was used as dicamba potassium salt (“dicamba-K”) or as dicamba N,N-bis(3-aminopropyl)methylamine salt (“dicamba-BAPMA”) and the amount in Table 1 in WI refers to the dicamba acid equivalents.

The samples A to G were clear solutions. They remained clear solution after storage for at least four weeks at room temperature.

TABLE 1
Composition of solutions [g/l]

| | A | B | C | D | E | F | G |
|---|---|---|---|---|---|---|---|
| Dicamba-K | | 400 | 400 | 400 | 400 | 400 | 400 |
| Dicamba-BAPMA | 400 | | | | | | |
| K₂CO₃ | 200 | 150 | 150 | 150 | 150 | 150 | 150 |
| Antidrift A | 100 | 100 | 50 | 100 | 100 | 50 | 100 |
| Surfactant A | | 27 | 27 | 27 | | | |
| Surfactant B | | 100 | 100 | 50 | 100 | 100 | 50 |
| Ethylene glycol | | 53 | 53 | 53 | 53 | 53 | 53 |
| Surfactant C | | | | | 27 | 27 | 27 |
| Water | ad | ad | ad | ad | ad | ad | ad |
| | 1 L | 1 L | 1 L | 1 L | 1 L | 1 L | 1 L |

1-16. (canceled)

17. An aqueous composition comprising at least 200 g/l of an anionic pesticide, at least 50 g/l of an inorganic base and at least 20 g/L of a drift control agent of the formula (I)
R^{a}—O—(CₘH₂ₘ—O)ₙ—H (I)
wherein R^{a} is C₈-C₂₂-alkyl and/or -alkenyl, m is 2, 3, 4 or a mixture thereof, and n is from 1 to 15.

18. The composition according to claim 17 wherein R^{a} is C₁₆-C₁₈-alkyl and/or -alkenyl, m is 2, and n is from 2 to 5.

19. The composition according to claim 17 comprising a a sugar-based surfactant.

20. The composition according to claim 19 comprising at least 20 g/l of the sugar-based surfactant.

21. The composition according to claim 17 wherein the sugar-based surfactant contains an alkyl polyglucoside.

22. The composition according to claim 17 comprising a total of at least 500 g/l of the sum of the anionic pesticide and the base.

23. The composition according to claim 17 comprising at least 350 g/l of the anionic pesticide, at least 100 g/l of the base, and at least 30 g/l of the drift control agent.

24. The composition according to claim 17 wherein the base contains sodium carbonate, sodium hydrogencarbonate, potassium carbonate, potassium hydrogencarbonate, or mixtures thereof.

25. The composition according to claim 17 wherein the base contains alkaline or earth alkaline salts of secondary or tertiary phosphates, pyrrophosphates, and oligophosphates or mixtures thereof.

26. The composition according to claim 17 wherein the anionic pesticide contains dicamba.

27. The composition according to claim 17 comprising at least 350 g/l of the anionic pesticide which contains dicamba, at least 100 g/l of the base which contains sodium carbonate, sodium hydrogencarbonate, potassium carbonate, potassium hydrogencarbonate, or mixtures thereof, and at least 30 g/l of the drift control agent, in which R^{a} is C₁₆-C₁₈-alkyl and/or -alkenyl, m is 2, and n is from 2 to 5.

28. The composition according to claim 17 comprising at least 350 g/l of the anionic pesticide which contains dicamba, at least 100 g/l of the base which contains alkaline or earth alkaline salts of secondary or tertiary phosphates, pyrrophosphates, and oligophosphates or mixtures thereof, and at least 30 g/l of the drift control agent, in which R^{a} is C₁₆-C₁₈-alkyl and/or -alkenyl, m is 2, and n is from 2 to 5.

29. The composition according to claim 17, wherein the composition is present in form of a solution.

30. A method for preparing the composition as defined in claim 17 comprising the step of contacting the anionic pesticide and the inorganic base.

31. A method of combating harmful insects and/or phytopathogenic fungi, which comprises contacting plants, seed, soil or habitat of plants in or on which the harmful insects and/or phytopathogenic fungi are growing or may grow, plants, seed or soil to be protected from attack or infestation by said harmful insects and/or phytopathogenic fungi with an effective amount of the composition according to claim 17.

32. A method of controlling undesired vegetation, which comprises allowing a herbicidal effective amount of the composition according to claim 17 to act on plants, their habitat or on seed of said plants.

33. The method according to claim 32 wherein, in formula (I), R^{a} is C₁₆-C₁₈-alkyl and/or -alkenyl, m is 2, and n is from 2 to 5.

34. The method according to claim 32, wherein the composition comprises a sugar-based surfactant.

35. The method according to claim 34 wherein the composition comprises at least 20 g/l of the sugar-based surfactant.

36. The method according to claim 34 wherein the sugar-based surfactant contains an alkyl polyglucoside.
